(19) United States
(12) Patent Application Publication
(10) Pub. No.: US 2019/0283686 A1
(43) Pub. Date: Sep. 19, 2019

(54) VEHICLE MOUNTABLE DYNAMIC DISPLAY DEVICE

(71) Applicant: FORD GLOBAL TECHNOLOGIES, LLC, DEARBORN, MI (US)

(72) Inventors: Uwe Gussen, Hürtgenwald (DE); Christoph Arndt Dr habil, Mörlen (DE); Frank Petri, Erftstadt (DE); Frederic Stefan, Aachen (DE)

(21) Appl. No.: 16/299,473

(22) Filed: Mar. 12, 2019

(30) Foreign Application Priority Data
Mar. 14, 2018 (DE) 102018203857.0

(51) Int. Cl. B60R 11/02; B60Q 1/50; G08G 1/09; B60R 13/10

(52) U.S. Cl. CPC B60R 11/0229; B60Q 1/503; B60R 2011/004; B60R 13/105; G08G 1/09

(57) ABSTRACT

A display device for a vehicle includes at least one mounting attachment for attaching the device to any component of the vehicle and includes a communication device that receives data from a couplable device and includes at least one display area for the visual output of any information.

### CROSS REFERENCE TO RELATED APPLICATIONS

The present application claims the benefit to German patent application DE102018203857.0, filed Mar. 14, 2018, the contents of which are incorporated herein in their entirety.

### BACKGROUND OF THE INVENTION

The present invention concerns a display device for a vehicle. The invention also concerns a vehicle and a method for displaying information by means of a display device on a surface of a vehicle.

In the information age, everyone has the freedom to decide which type of information he wants to receive, or in which form he provides information. This also includes the frequency of updating, the size of information packages and the form of a possible display. Of course, vehicles, motor cycles, cycles or other mobile systems comprise a limited and usually specified area for the display of information. Therefore, personalization or individualization on the existing displays and an individual layout are limited. The existing configurations are typically based on predefined rules, for example legal regulations or specifications of OEMs or other restrictions.

If a person wants additional information devices, then this is mainly limited to personal devices, such as for example tablets, smartphones, etc. In particular, as a rule a required attachment in this context is subject to restrictions. Moreover, safety when driving the vehicle can be adversely affected. At the same time, users are interested in visual personalization of their vehicle, for example by means of stickers, displays or special labels. Some of these markings, such as license plates and inspection plates, are already prescribed by law.

In the document US 2005/0039365 A1, a digital license plate is described. In the documents US 2014/0005860 A1 and US 2014/0141840 A1, digital labels are described that can be coupled to mobile devices.

### SUMMARY OF THE INVENTION

Against the described background, it is the object of the present invention to provide an improved possibility that enables a user of a vehicle to display individual and/or personalized information.

The display device according to the invention, which can for example be a legend plate or a display panel, is designed for a vehicle. It comprises at least one mounting attachment for attaching the device to any component of the vehicle, especially to a freely selectable component of the vehicle. The display device also comprises a communication device that is designed to receive data from a device that can be coupled, in particular a coupled device. The display device also comprises at least one display area for the visual output of any information, in particular of freely selectable information. The information can for example be signals, images, legends or other visually displayed data.

The display device according to the invention has the advantage that it provides the possibility for the display and output of information that can be formatted individually by a user to third parties. In contrast to a digital license plate, the user can arbitrarily position the display device according to the invention in or on the vehicle and can display contents selected by him.

The mounting attachment is preferably designed for easy removal of the display device from a component of the vehicle. The mounting attachment can for example be a surface with an adhesive area and/or a hook and loop surface, i.e. a surface with fastening hooks or a surface for fastening to fastening hooks, and/or at least one suction cup and/or at least one hook and/or a screw connection and/or a magnetic connection. In this case, any combination of the mentioned mounting attachment is possible. The easy removal has the advantage that the display device can be attached to different positions within or outside the vehicle and said position can be changed over time.

Advantageously, the mounting attachment is designed for attaching the device to a surface within the vehicle (internal surface) and/or to an external surface of the vehicle. This enables a flexible application option for the display device, wherein in particular a specific placement of the receiver that is adapted to the potential information to be displayed is enabled.

The vehicle can for example be a motor vehicle, a trailer, a cycle, a single-axle vehicle, for example a SEGWAY, or a wheelchair. The motor vehicle can in particular be a passenger vehicle, a truck, a motor cycle or a moped.

The communication device is preferably designed for connecting to a mobile device, for example a cell phone, a smartphone, a tablet, a smartwatch or another mobile device. The communication device can additionally or alternatively be designed for connecting to a network, for example Wi-Fi, W-LAN, LAN, Internet, a cloud, Car2Infrastructure, Car2Car, Bluetooth (BT) or LTE. This enables data to be transmitted to the display device in a temporally and spatially flexible manner and information to be output via the display area.

In one advantageous version, the display device comprises at least one surface comprising deformable material. In this case, this can in particular be material that is flexible in at least one direction. The material can be plastically or elastically deformable, for example pliable. In a preferred version, at least one surface is arranged so that the shape thereof can be deformed in a direction perpendicular to the surface, in particular in a direction parallel to a normal to a surface of a region of said surface. Advantageously, the means of attachment and/or the display area can comprise a surface that comprises deformable material. This has the advantage that the display device can be attached to a curved surface so that the at least one surface conforms or is adapted to the curved shape. As a result, at the same time it is avoided that the display area lifts off disruptively from the surface of the vehicle on which it is disposed.

As the deformable material, for example flexibles glass and/or a material comprising graphene, and/or flexible electronic paper (e-paper) and/or organic thin film transistor material (OTFT—Organic Thin Film Transistor) and/or MEMS surfaces can be used. Furthermore, OLED technology and/or a suitable display technology and/or projection technology can be used.

In a further version, the display device is designed as a provisional license plate and/or as a means for displaying individually designed information. The possibility of the use of a provisional license plate has the advantage that costs and time for the manufacture of a suitable license plate can be saved. If the display device is also designed at the same time as a means for displaying individually designed information, this has the advantage that the display device can be used in a significantly more versatile manner than a conventional digital license plate and thus costs and material for a provisional license plate can be saved. The use as a means for displaying individually designed information has the advantage that a number of purposeful and useful information items, in particular also in connection with safety when operating the vehicle, can be displayed to other road users or a wider public. Examples of this will be described in detail in connection with the description of exemplary embodiments.

The vehicle according to the invention comprises a previously described display device according to the invention. Said device has basically the same properties and advantages as the previously described display device. The vehicle can be one of the vehicles already mentioned above.

The method according to the invention for displaying information by means of a display device according to the invention described above, which is attached to a surface of a vehicle, comprises the following steps: The communication device is coupled to a couplable device, for example a mobile device. From the couplable device, data are transmitted to the display device. Visual information based on the transmitted data is output by means of the display area. The couplable device can be a mobile device or a device that is fixedly connected to the vehicle, for example a component of the vehicle controller. The method according to the invention has the properties and advantages already mentioned above in connection with the display device according to the invention.

### BRIEF DESCRIPTION OF THE DRAWINGS

The invention is described in detail below using exemplary embodiments with reference to the accompanying figures. Although the invention is illustrated and described in detail by the preferred exemplary embodiments, the invention is not limited by the disclosed examples and other variations can be derived therefrom by the person skilled in the art without departing from the protective scope of the invention.

The figures are not necessarily accurate in every detail and true to scale and can be shown enlarged or reduced to give a better overview. Therefore, functional details that are disclosed here shall not be considered to be limiting, but only as a descriptive basis that provides the person skilled in this field of technology with guidance for using the present invention in various ways.

The expression “and/or” that is used here, if used in a sequence of two or more elements, means that each of the mentioned elements can be used on its own, or any combination of two or more of the mentioned elements can be used. If for example a combination is described that contains the components A, B and/or C, the combination can contain A alone; B alone; C alone; A and B in combination; A and C in combination; B and C in combination; or A, B, and C in combination.

FIG. 1 shows a schematic perspective view of a display device.

FIG. 2 shows a schematic side view of a vehicle having display devices removably mounted thereto.

### DETAILED DESCRIPTION

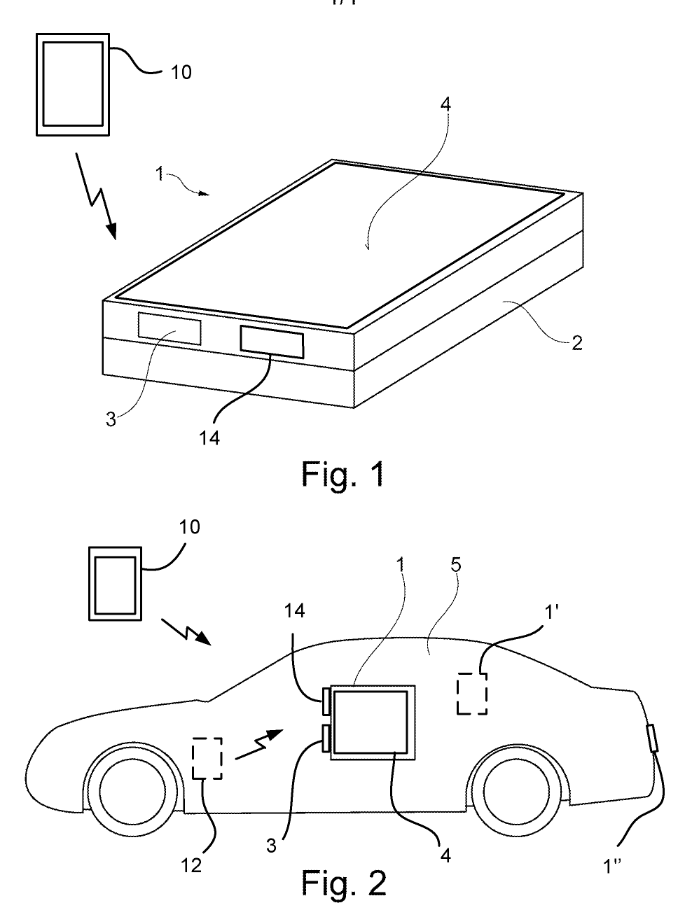

FIGS. 1 and 2 show schematically a display device 1 and attachment to an automotive vehicle 5. The display device 1 is configured for use with a vehicle, for example a motor vehicle, a trailer, a cycle, a single-axle vehicle (for example a SEGWAY) or a wheelchair. The motor vehicle can be the passenger vehicle 5 or a truck, a motor cycle or a moped.

The display device 1 includes at least one mounting attachment 2 for attaching the device 1 to a component of the vehicle 5. In the case of a motor vehicle, in particular in the case of the passenger vehicle 5, the mounting attachment 2 can be designed for attaching the device 1 to an external surface of the vehicle 5. In addition or alternatively thereto, the mounting attachment 2 can be designed for attaching the device 1′ to an internal surface, i.e. a surface within the motor vehicle 5, for example to a surface of and instrument panel, to a screen, to a seat or to a trunk lid (not shown).

The mounting attachment is preferably configured for easy removal of the display device from a component of the vehicle. The mounting attachment 2 may be, for example, a surface with an adhesive area and/or a hook and loop surface, i.e. a surface with fastening hooks or a surface for fastening to fastening hooks, and/or at least one suction cup and/or at least one hook and/or a screw connection and/or a magnetic connection. In this embodiment, any combination of the mounting attachments is contemplated. The easy removal has the advantage that the display device 1 may be attached to different positions within or outside the vehicle 5 and the position may be changed over time.

The display device 1 may include at least one surface comprising deformable material. This may be material that is flexible in at least one direction. The material can be plastically or elastically deformable, for example pliable. There may be at least one surface arranged so that the shape thereof can be deformed in a direction perpendicular to the surface, in particular in a direction parallel to a normal to a surface of a region of the surface. The mounting attachment 2 and/or the display area 4 may form a surface that comprises deformable material. This has the advantage that the display device 1 can be attached to a curved surface so that the at least one surface conforms or is adapted to the curved shape. As a result, at the same time it is avoided that the display area 4 lifts off disruptively from the surface of the vehicle 5 on which it is disposed.

The deformable material may be, for example, flexibles glass and/or a material comprising graphene, and/or flexible electronic paper (e-paper) and/or organic thin film transistor material (OTFT—Organic Thin Film Transistor) and/or micro-electromechanical systems (MEMS) surfaces may be used. Furthermore, organic light emitting diode (OLED) technology and/or a suitable display technology and/or projection technology may be used.

The display device 1 also includes a communication device 3 that is designed to receive data from a couplable device 10, for example from a mobile device, such as in particular a cell phone, a smartphone, a smartwatch or a tablet. The couplable device 10 can also be a device that is fixedly connected to the vehicle 5, such as for example a component of the vehicle controller 12.

Moreover, the display device 1 includes at least one display area 4 for the visual output of information. The display area 4 can be part of a display device 1 that is separate from the mounting attachment 2 and/or the communication device 3.

The display device may further include a power source 14, which may be, for example, a rechargeable battery.

The display device 1 may, for example, display a temperature within and/or outside the vehicle 5. In contrast to previously known temperature displays in a vehicle system that only display the temperature when the ignition key has been operated, the temperature within the vehicle 5 can be displayed to any person outside the vehicle 5 by means of the display device 1 even when an ignition of the vehicle 5 is off.

The display device 1 may display forwarding messages, in particular short messages, to a person in a vehicle next to the vehicle 5. The messages may for example contain information regarding the need for the next refueling, refilling liquid in the windscreen wiper system or other information.

The display device 1 may display a parking duration. More specifically, the arrival time at a parking space and the planned parking duration, for example the end of the planned parking, are displayed on the display area 4. In this case, the end of the parking time can for example be updated by means of the mobile device 10, for example extended stay in the parking space. The parking spaces that will be coming free shortly can be easily identified by those looking for a parking space.

The display device 1 may display information or signals for the rapid and efficient formation of an emergency lane and coordination of the formation of an emergency lane. In addition, intended changes of driving direction can already be displayed and transmitted before the operation of an indicator. In addition, traffic information, such as for example traffic jam information, may be displayed on the device 1 in a timely and efficient manner to other road users.

The display device 1″ may be used as a provisional license plate until the creation of the final license plate. As a result, resources related to the manufacture of provisional license plates can be saved.

The display device 1 may be used to create a unique visual appearance of the vehicle 5 and to transmit advertisements, personal information, car sharing information or cycle sharing information, and to use it as an advertising space. In the context of the vehicle 5 being a truck, in particular information about the load state and/or information about available time windows for loading or unloading etc. may be displayed.

The display device 1 may facilitate the locating of one's own vehicle 5 by means of a specific display on the display area 4 in the context of parking in large parking sites.

The display device 1 may automatically display needed information when crossing national borders, such as for example different speed limits or generally different traffic laws.

Moreover, maintenance notices can be individually displayed on the display area 4 by the display device 1. Or, parking entitlements for certain parking zones or purchased vignettes or tolls paid for certain lanes may also be transmitted and displayed on the display area 4.

While certain embodiments of the present invention have been described in detail, those familiar with the art to which this invention relates will recognize various alternative designs and embodiments for practicing the invention as defined by the following claims.

1. A vehicle comprising:
a mounting surface; and
a display device including a deformable mounting attachment removably secured to the mounting surface, a display area configured to selectively display information, and a communication device configured to wirelessly receive information and display the information in the display area.

2. The vehicle of claim 1 wherein the display area is deformable.

3. The vehicle of claim 1 wherein the communication device is configured to wirelessly connect to a mobile device.

4. The vehicle of claim 1 wherein the mounting surface is exterior vehicle structure.

5. The vehicle of claim 1 wherein the mounting surface is interior vehicle structure.

6. The vehicle of claim 1 wherein the mounting surface is license plate holder.

7. The vehicle of claim 1 wherein the mounting attachment is a hook and loop assembly.

8. The vehicle of claim 1 wherein the mounting attachment is a magnetic assembly.

9. The vehicle of claim 1 wherein mounting attachment is at least one suction cup.

10. The vehicle of claim 1 wherein the display area is deformable and comprises flexible electronic paper.

11. The vehicle of claim 1 wherein the display area is deformable and comprises organic thin film transistor material.

12. A method of operating a vehicle comprising:
mounting a display device on a mounting surface of the vehicle by:
deforming a mounting attachment to essentially match a curvature of the mounting surface;
removably mounting the mounting attachment to the mounting surface;
receiving information via a wireless signal by the display device; and
displaying the information on a display area of the display device.

13. The method of claim 12 further including deforming the display area to essentially match the curvature of the mounting surface.

14. The method of claim 12 wherein the information received and displayed is a temperature from one of at least inside and outside of the vehicle temperature.

15. The method of claim 12 wherein the information receive and displayed is a short text message directed toward a second vehicle adjacent to the vehicle.

16. The method of claim 12 wherein the information received and displayed is a planned parking space duration when the vehicle is in a parking space.

17. The method of claim 12 wherein the information received and displayed is emergency lane indication directed toward a second vehicle adjacent to the vehicle.

18. The method of claim 12 wherein the information received and displayed is provisional license plate number and the mounting surface is license plate holder.

19. The method of claim 12 wherein the information received and displayed is information for crossing an international border when the vehicle is approaching an international border.
